(19) United States
(12) Patent Application Publication
(10) Pub. No.: US 2007/0166552 A1
(43) Pub. Date: Jul. 19, 2007

(54) Polyurethane-polyurea coatings

(76) Inventors: Steffen Hofacker, Odenthal (DE); Thomas Feller, Solingen (DE); Jurgen Kocher, Langenfeld (DE)

Correspondence Address: BAYER MATERIAL SCIENCE LLC, 100 BAYER ROAD, PITTSBURGH, PA, 15205, US

(21) Appl. No.: 11/651,637

(22) Filed: Jan. 10, 2007

(30) Foreign Application Priority Data
Jan. 17, 2006 (DE) 102006002154.1

(51) Int. Cl. B32B 27/40; C08L 75/00; C08G 18/00

(52) U.S. Cl. 428/423.1; 525/452

(57) ABSTRACT

The present invention provides coating agents made up of the reaction product of
a) a polycarbonatediol component comprising
   a1) a polytetramethylene glycol-based polycarbonatediol with a molecular weight of between 400 and 8000, and
   a2) optionally other polyols with a molecular weight of from 200 to 8000,
b) 0.5-2.0 mol per mol of a) of a chain extender selected from the group consisting of a low-molecular weight aliphatic or cycloaliphatic diol, a low-molecular weight aliphatic or cycloaliphatic diamine, and hydrazine, and
c) 1.5-3.0 mol per mol of a) of an aliphatic, cycloaliphatic or aromatic diisocyanate,
   dissolved in
d) 40-90 percent by weight (based on the total formulation) of an organic solvent selected from the group consisting of linear or cyclic esters, ketones, alcohols, aromatic compounds and mixtures thereof.

### CROSS-REFERENCE TO RELATED APPLICATIONS

The present application claims the right of priority under 35 U.S.C. §119 (a)-(d) of German Patent Application Number 102006002154, filed Jan. 17, 2006.

### BACKGROUND OF THE INVENTION

The invention relates to novel products for the coating of substrates with polyurethane-polyureas and to the substrates coated therewith.

The coating of substrates with polyurethane systems is state of the art. A distinction is made here between aqueous polyurethane dispersions and solvent-based systems.

Aqueous polyurethane systems cover a large field of application and have the advantage of being substantially free of volatile organic substances. However, by virtue of their necessarily hydrophilic character, coatings produced from these systems have a lower water resistance than the corresponding polyurethane coatings produced from organic solutions, since the hydrophilizing groups remain in the coating film.

If it is desired to produce coatings with good water resistance, polyurethane systems based on organic solvents are preferable to aqueous systems. In the case of one-component polyurethanes the film forming process is a physical process which, in contrast to two-component polyurethanes, is not accompanied by a chemical reaction.

Solvent-based one-component systems contain polyurethanes dissolved in organic solvents. In these systems the film forming process is a physical process which, in contrast to the two-component polyurethane coatings that are also state of the art, is not accompanied by a chemical reaction.

One-component polyurethane-polyurea coatings (also called one-component polyurethane-urea coatings) based on organic solvents are greatly valued by users on account of their hardness, elasticity and resistance and are used e.g. for the production of covering layers on textiles. Such systems are prepared by reacting an aliphatic or aromatic diisocyanate with a linear macrodiol (polyether-, polyester- or polycarbonatediol) to give a prepolymer, and then adjusting the molecular weight to the required value by reaction with an aliphatic diamine as a chain extender.

Particularly good properties with respect to resistance and tensile strength are achieved by preparing polyurethane-ureas which contain a polycarbonatediol as the macrodiol component (e.g. DE-A 2 252 280, WO 2004/101640). These poly-carbonatediol components of the state of the art are prepared from aliphatic diols by reaction with phosgene (e.g. DE-A 1 595 446), bis-chlorocarbonic acid esters (e.g. DE-A 857 948), diaryl carbonates (e.g. DE-A 1 012 557), cyclic carbonates (e.g. DE-A 2 523 352) or dialkyl carbonates (e.g. WO 2003/2630). In the reaction of aliphatic diols with aryl carbonates such as diphenyl carbonate, a sufficient conversion is achieved simply by removing the alcohol component released (e.g. phenol) in the course of the equilibrium shift of the reaction (e.g. EP-A 0 533 275).

However, if alkyl carbonates (e.g. dimethyl carbonate) are used, transesterification catalysts are commonly employed. Examples of such catalysts are alkali metals or alkaline earth metals and their oxides, alkoxides, carbonates, borates or organic acid salts (e.g. WO 2003/002630), organotin compounds such as bis(tributyltin)oxide, dibutyltin laurate or dibutyltin oxide (e.g. DE-A 2 523 352), titanium compounds such as titanium tetrabutylate, titanium tetraisopropylate or titanium dioxide (e.g. EP-A 0 343 572, WO 2003/002630), and ytterbium compounds such as ytterbium(III) acetylacetonate (EP-A 1 477 508).

The increase in market demands now makes it necessary to further improve the material properties of polyurethane-polyurea solutions containing polycarbonatediols as a structural component. Said properties include the extensibility in particular. The object of the present invention is to provide such products with improved extensibility. These products are therefore particularly suitable for the coating of extensible or flexible materials such as textiles, leather or plastics.

The state of the art (e.g. DE-A 2 252 280 or WO 2004/101640) preferentially uses polycarbonatediols prepared from short-chain aliphatic diols, the most commonly used diol being 1,6-hexanediol.

It has now been found that polycarbonatediols consisting of polytetramethylene glycol structural units with number-average molecular weights of 200 g/mol to 3000 g/mol can be processed to coating agents based on polyurethane-urea solutions with very high extensibility.

### SUMMARY OF THE INVENTION

The present invention provides coating agents comprising the reaction product of
a) a polycarbonatediol component comprising
   a1) a polytetramethylene glycol-based polycarbonatediol with a molecular weight of between 400 and 8000, and
   a2) optionally other polyols with a molecular weight of between 200 and 8000,
b) 0.5-2.0 mol per mol of a) of a chain extender selected from the group consisting of a low-molecular weight aliphatic or cycloaliphatic diol, a low-molecular weight aliphatic or cycloaliphatic diamine, and hydrazine, and
c) 1.5-3.0 mol per mol of a) of an aliphatic, cycloaliphatic or aromatic diisocyanate,

dissolved in
d) 40-90 percent by weight (based on the total formulation) of an organic solvent selected from the group consisting of linear or cyclic esters, ketones, alcohols, aromatic compounds and mixtures thereof.

Preferred coating agents are those made up of the reaction product of
a) a polytetramethylene glycol-based polycarbonatediol with a molecular weight of between 600 and 3000,
b) 0.5-2.0 mol per mol of a) of a chain extender selected from the group consisting of an aliphatic or cycloaliphatic diamine and hydrazine, and
c) 1.5-3.0 mol per mol of a) of an aliphatic or cycloaliphatic diisocyanate,

dissolved in
d) 50-85 percent by weight (based on the total formulation) of an organic solvent selected from the group consisting of ethyl acetate, n-butyl acetate, 1-methoxy-2-propyl acetate, γ-butyrolactone, acetone, 2-butanone, ethanol, n-propanol, isopropanol, 1-methoxy-2-propanol, solvent naphtha, toluene and mixtures thereof.

The coating agents according to the invention are particularly suitable for textile fabrics. They are high-molecular weight, but virtually non-crosslinked, thermoplastic polyurethane-ureas prepared in solution or in the melt. The dried films of these coating agents are distinguished by outstanding properties such as the adhesion and hardness of the dried film; the high extensibility of these coatings may be emphasized in particular.

The polytetramethylene glycol-based polycarbonatediols are prepared by processes which are described e.g. in EP-A 1 477 508 for diols such as 1,6-hexanediol. In place of 1,6-hexanediol, polytetramethylene glycol polyetherdiols are prepared with phosgene, bis-chlorocarbonic acid esters, diaryl carbonates, cyclic carbonates or dialkyl carbonates. Synthesis using a dialkyl carbonate, e.g. dimethyl carbonate or diethyl carbonate, is preferred. Possible diols of the type mentioned are the polytetramethylene glycol polyetherdiols known per se in polyurethane chemistry, which can be prepared e.g. via the polymerization of tetrahydrofuran by cationic ring opening. The products are therefore also called poly-THF compounds. The polytetramethylene glycol-based polycarbonatediols preferably have a number-average molecular weight Mn of 400 to 8000 g/mol, particularly preferably of 600 to 3000 g/mol. These compounds normally have an OH functionality of 1.7 to 2.0, preferably of 1.8 to 2.0 and particularly preferably of 1.9 to 2.0.

The optional polyols which can be mixed with the polytetramethylene glycol-based polycarbonatediols in the polycarbonatediol component are known polyether-, polyester- and polycarbonatediols with a number-average molecular weight Mn of 200 to 8000 g/mol, preferably of 600 to 4000 g/mol and particularly preferably of 600 to 3000 g/mol. These polyols have a functionality of 1.7 to 2.0, preferably of 1.8 to 2.0 and particularly preferably of 1.9 to 2.0. A selection of possible known polyetherdiols and polyesterdiols are described in D. Dieterich, Houben-Weyl volume E 20, Thieme Verlag 1987. The known polycarbonatediols suitable as the optional polyol are mentioned e.g. in EP-A 1 477 508, page 2, lines 6-10.

Preferably, both the polytetramethylene glycol-based polycarbonatediols and the optional polyols are linear.

The proportion of polytetramethylene glycol-based polycarbonatediols in the polycarbonatediol component is 50 to 100 wt. %, preferably 75 to 100 wt. %. Particularly preferred reaction mixtures are those in which 100% of the polycarbonatediol component used is a polytetramethylene glycol-based polycarbonatediol.

The effect of the low-molecular weight diols or low-molecular weight diamines used to synthesize the polyurethane resins is normally to stiffen or branch the polymer chain. The molecular weight of these diols or diamines can be chosen out of a broad range. Usually those diols or diamines are taken which have a molecular weight in the range of 50 to 500 g/mol. By “low-molecular weight,” it is meant that the molecular weight of such chain extenders is preferably between 62 and 200 g/mol. In a few cases diols or diamines with a molecular weight between 200 and 400 g/mol can be used too.

Suitable low-molecular weight diols can contain aliphatic, alicyclic or aromatic groups. Examples which may be mentioned here are low-molecular weight diols having up to about 20 carbon atoms per molecule, e.g. ethylene glycol, diethylene glycol, 1,2-propanediol, 1,3-propanediol, 1,4-butanediol, 1,3-butylene glycol, cyclohexanediol, 1,4-cyclohexane-dimethanol, 1,6-hexanediol, neopentyl glycol, hydroquinone dihydroxyethyl ether, bisphenol A (2,2-bis(4-hydroxyphenyl)propane). and hydrogenated bisphenol A (2,2-bis(4-hydrocyclohexyl)propane). Esterdiols, e.g. α-hydroxybutyl-ε-hydroxycaproic acid esters, ω-hydroxyhexyl-γ-hydroxybutyric acid esters, β-hydroxyethyl adipate or bis(β-hydroxyethyl) terephthalate, can also be used.

To prepare the polyurethane coatings according to the invention, it is preferable to use diamines as chain extenders. Such chain extenders are hydrazine or aliphatic diamines, e.g. ethylenediamine, propylenediamine, 1,6-hexamethylenediamine or other aliphatic diamines. Other possible diamines are cycloaliphatic diamines such as 1,4-bis(aminomethyl)cyclohexane, 4,4′-diamino-3,3′-dimethyldicyclohexylmethane and other (C₁-C₄)-dialkyl- and -tetraalkyldicyclohexylmethanes, e.g. 4,4′-diamino-3,5-diethyl-3′,5′-diisopropyldicyclohexylmethane. 1-amino-3,3,5-trimethyl-5-aminomethyl-cyclohexane(isophoronediamine) and 4,4′-diaminodicyclohexylmethane are particularly preferred.

About 0.5-2.0 mol of chain extenders, preferably 0.7-1.7 mol and particularly preferably 0.7-1.7 mol are used per mol of polycarbonatediol component a).

Conventionally, approximately equivalent amounts of chain extenders are used, based on residual isocyanate, less the amount of isocyanate reacted with the macrodiol mixture. It is preferable, however, to use less than the equivalent amount, down to about 80% of the NCO groups. The residual NCO groups can be reacted with monofunctional terminators such as aliphatic monoalcohols, aliphatic monoamines, butanone oxime, trialkoxysilylpropanamine or morpholine. This prevents excessive growth of the molecular weight or crosslinking and branching reactions. The alcohols present in the solvent mixture can also act in this form as chain extenders.

The diisocyanates c) used can be any of the aliphatic, cycloaliphatic and/or aromatic isocyanates known to those skilled in the art which have a mean NCO functionality of ≧1, preferably of ≧2, individually or in any desired mixtures with one another, it being unimportant whether they have been prepared using phosgene or by phosgene-free processes.

Examples of aromatic diisocyanates are 1,4-phenylene diisocyanate, 2,4- and/or 2,6-toluylene diisocyanate, 1,5-naphthylene diisocyanate, 2,4′- or 4,4′-diphenylmethane diisocyanate and 4,4′,4″-triphenylmethane triisocyanate.

The isocyanates used are preferably selected from the aliphatic or cycloaliphatic representatives, these having a carbon skeleton (without the NCO groups) of 3 to 30 carbon atoms, preferably of 4 to 20 carbon atoms, e.g. bis(isocyanatoalkyl)ethers, bis- and tris(isocyanatoalkyl)benzenes, -toluenes and -xylenes, propane diisocyanates, butane diisocyanates, pentane diisocyanates, hexane diisocyanates (e.g. hexamethylene diisocyanate, HDI), heptane diisocyanates, octane diisocyanates, nonane diisocyanates (e.g. trimethyl-HDI (TMDI), normally as a mixture of the 2,4,4 and 2,2,4 isomers), nonane triisocyanates (e.g. 4-isocyanatomethyl-1,8-octane diisocyanate), decane diisocyanates, decane triisocyanates, undecane diisocyanates, undecane triisocyanates, dodecane diisocyanates, dodecane triisocyanates, 1,3- and 1,4-bis(isocyanatomethyl)cyclohexanes (H₆XDI), 3-isocyanatomethyl-3,5,5-trimethylcyclohexyl isocyanate (isophorone diisocyanate, IPDI), bis(4-isocyanato-cyclohexyl)methane (H₁₂MDI) or bis(isocyanatomethyl)norbomane (NBDI).

Particularly preferred compounds of component c) are hexamethylene diisocyanate (HDI), trimethyl-HDI (TMD), 2-methyl-1,5-pentane diisocyanate (MPDI), isophorone diisocyanate (IPDI), 1,3- and 1,4-bis(isocyanatomethyl)cyclohexane (H₆XDI), bis(isocyanatomethyl)norbomane (NBDI), 3(4)-isocyanatomethyl-1-methylcyclohexyl isocyanate (IMCI) and/or 4,4′-bis(isocyanatocyclohexyl)methane (H₁₂MDI), or mixtures of these isocyanates.

Very particularly preferred compounds of component c) are hexamethylene diisocyanate (HDI), isophorone diisocyanate (IPDI) and 4,4′-bis(isocyanatocyclo-hexyl)methane (H₁₂MDI), or mixtures of these isocyanates.

About 1.5-3.0 mol, preferably 1.6 to 2.9 mol and particularly preferably 1.7-2.8 mol of diisocyanate component c) are used per mol of polycarbonatediol component a).

The present invention also provides a process for the preparation of the coating agents according to the invention, characterized in that 1.5-3.0 mol of diisocyanate are used per mol of polycarbonatediol component a). The polycarbonatediol component a) and the diisocyanate c) are reacted together in the melt or in solution until all the hydroxyl groups have been consumed. Other solvents and the chain extending reagent (either a low-molecular weight diol or, preferably, a low-molecular weight amine), optionally in solution, are then added. After the target viscosity of 10,000 mPas to 70,000 mpas has been reached, the NCO residues are blocked with a monofunctional compound such as an aliphatic monoalcohol, an aliphatic monoamine, butanone oxime, trialkoxysilylpropanamine or morpholine.

Possible solvents for the production and application of the coatings according to the invention are mixtures of linear or cyclic esters, ketones, alcohols and aromatic solvents. An example of a cyclic ester is γ-butyrolactone, examples of linear esters are ethyl acetate, n-butyl acetate or 1-methoxy-2-propyl acetate, examples of ketones are acetone and 2-butanone, examples of alcohols are ethanol, n-propanol, isopropanol and 1-methoxy-2-propanol, and examples of aromatic solvents are solvent naphtha or toluene.

The coatings according to the invention have melting points above 100° C., preferably of 130° C. to 220° C. They possess a high adhesion, surface hardness, elongation at break and ultimate tensile strength.

They can be applied in 10-60% solution, preferably in 15 to 50% solution.

The coating agents prepared with the polyurethanes according to the invention are preferably used for the coating of textile fabrics. They can be applied directly by printing, spraying or knife coating or by means of transfer coating. The coating agents according to the invention are of particular importance for the production of textile-based coated articles by the transfer process, the coating agents according to the invention being used as covering layers at a rate of 5 to 60 g/m².

The coating solutions according to the invention can also advantageously be used for multilayer textile coatings. In this multilayer structure a distinction is made between the adhesive layer, which is the direct coating on the textile substrate, and the covering layer, which is the coating applied to the adhesive layer. There can also be a third layer, the so-called interlayer, between the adhesive layer and the covering layer. The polyurethane-urea solutions according to the invention can be used for all three layers. The products are used preferably as interlayers and covering layers and particularly preferably as covering layers.

Conventional additives and auxiliary substances, such as gripping aids, pigments, dyestuffs, matting agents, UV stabilizers, phenolic antioxidants, light stabilizers, hydrophobic agents and/or flow control agents, can be used concomitantly.

The coatings obtained with the coating solutions according to the invention are distinguished by an exceptionally high extensibility.

The advantages of the coating solution according to the invention and the coatings obtained therefrom are illustrated by means of comparative experiments in the Examples which follow.

### EXAMPLES

The dynamic viscosities of the polyisocyanate resins were determined at 23° C. using a VT 550 viscometer with PK 100 cone-and-plate geometry from Haake (Karlsruhe, Germany). Measurements were made at different shear rates to ensure that the flow behaviour of the described polyisocyanate mixtures according to the invention, as well as that of the comparative products, corresponded to that of ideal Newtonian fluids. The details of the shear rate can therefore be omitted.

The NCO content of the resins described in the Examples and Comparative Examples was determined by titration according to DIN 53185.

The elongations at break were determined according to DIN 53504.

The percentages given are by weight unless the values are specified further.

### Example 1

### Preparation of a polycarbonatediol Based on polytetrahydro-furan 250 with a Number-Average Molecular Weight of Approx. 2000 g/mol

1867.1 g (6.11 mol) of polytetrahydrofuran with a number-average molecular weight of 250 g/mol (Polymeg® 250; BASF AG, Germany) were placed under a nitrogen atmosphere in a 1-liter three-necked flask equipped with stirrer and reflux condenser, and dehydrated for 2 h at 110° C. and a pressure of 20 mbar. The vacuum was then let down with nitrogen, 0.4 g of titanium tetraisopropylate and 690.9 g of dimethyl carbonate were added and the reaction mixture was refluxed for 24 h (oil bath temperature: 110° C.). The reflux condenser was then replaced with a Claisen bridge and the cleavage product formed (methanol) and dimethyl carbonate still present were distilled off. To do this, the temperature was raised from 110° C. to 150° C. over 2 h and held there for 4 h. It was then raised to 180° C. over 2 h and held there for a further 4 h. The reaction mixture was then cooled to 100° C. and a stream of nitrogen (2 l/h) was passed through it. Furthermore, the pressure was lowered stepwise to 20 mbar so that the top temperature did not exceed 60° C. during the continuing distillation. When 20 mbar had been reached, the temperature was raised to 130° C. and held there for 6 h. The polycarbonatediol obtained after the vacuum had been let down and the reaction mixture cooled was liquid at room temperature and had the following characteristics:

| | | |
|---|---|---|
| hydroxyl number (OH number): | 57.6 | mg KOH/g |
| viscosity at 23° C., D: 16: | 7000 | mPas |
| number-average molecular weight (Mₙ): | 1945 | g/mol |

### Example 2

### Preparation of a polycarbonatediol Based on polytetrahydro-furan 250 and 1,6-hexanediol with a Number-Average molecular Weight of Approx. 2000 g/mol

The procedure was basically the same as in Example 1 except that 2276.9 g of polytetrahydrofuran with a number-average molecular weight of 250 g/mol (Polymeg® 250; BASF AG, Germany), 881.0 g of 1,6-hexanediol and 1778.1 g of dimethyl carbonate were used as educts and 0.70 g of ytterbium acetylacetonate was used as catalyst.

The polycarbonatediol obtained was liquid at room temperature and had the following characteristics:

| | | |
|---|---|---|
| hydroxyl number (OH number): | 53.5 | mg KOH/g |
| viscosity at 23° C., D: 16: | 10,500 | mPas |
| number-average molecular weight (Mₙ): | 2090 | g/mol |

### Example 3

### Preparation of a polycarbonatediol Based on polytetrahydro-furan 650 with a Number-Average molecular Weight of Approx. 2000 g/mol

The procedure was the same as in Example 1 except that 584.6 g of polytetrahydrofaran with a number-average molecular weight of 650 g/mol (Polymeg® 650; BASF AG, Germany) and 79.9 g of dimethyl carbonate were used as educts and 0.12 g of ytterbium acetylacetonate was used as catalyst.

The polycarbonatediol obtained was liquid at room temperature and had the following characteristics:

| | | |
|---|---|---|
| hydroxyl number (OH number): | 58.3 | mg KOH/g |
| viscosity at 23° C., D: 16: | 3900 | mPas |
| number-average molecular weight (Mₙ): | 1921 | g/mol |

### Example 4

### Comparative Example of a polyurethane-urea Solution Using a polycarbonate Based on 1,6-hexanediol

This Comparative Example describes a product of the state of the art.

200 g of a polycarbonatediol with a number-average molecular weight of 2000 g/mol, prepared from dimethyl carbonate and 1,6-hexanediol, were mixed with 63.3 g of 1-methoxy-2-propyl acetate and 52.3 g of isophorone diisocyanate and the mixture was reacted at 110° C. to a constant NCO content of 3.60. It was allowed to cool and diluted with 211.2 g of γ-butyrolactone and 188.9 g of isopropanol. A solution of 24.6 g of 4,4′-diaminodicyclohexylmethane in 168.3 g of 1-methoxy-2-propanol was added at room temperature. When the molecular weight had finished increasing and the desired viscosity range had been reached, the residual NCO content was blocked by the addition of 1.5 g of n-butylamine. This gave 910.1 g of a 30.6% solution of polyurethane-urea in 1-methoxy-2-propyl acetate/γ-butyrolactone/isopropanol/1-methoxy-2-propanol with a viscosity of 21,500 mPas at 22° C.

### Example 5

### Polyurethane-urea Solution According to the Invention Using a polycarbonatepolyol of Example 1 based on polytetramethylene glycol

This Example describes the preparation of a polyurethane-urea according to the invention.

200 g of a polycarbonatediol of Example 1 according to the invention were mixed with 63.3 g of 1-methoxy-2-propyl acetate and 52.3 g of isophorone diisocyanate and the mixture was reacted at 110° C. to a constant NCO content of 3.60. It was allowed to cool and diluted with 211.2 g of γ-butyrolactone and 188.9 g of isopropanol. A solution of 22.3 g of 4,4′-diaminodicyclohexylmethane in 152.1 g of 1-methoxy-2-propanol was added at room temperature. When the molecular weight had finished increasing and the desired viscosity range had been reached, the residual NCO content was blocked by the addition of 4 g of n-butylamine. This gave 894.1 g of a 31.2% solution of polyurethane-urea in 1-methoxypropyl acetate/gamma-butyrolactone/isopropanol/1-methoxy-2-propanol with a viscosity of 16,800 mPas at 22° C.

### Example 6

### Polyurethane-urea Solution According to the Invention Using a polycarbonatepolyol of Example 2 Based on polytetramethylene glycol

This Example describes the preparation of a polyurethane-urea according to the invention.

200 g of a polycarbonatediol of Example 2 according to the invention were mixed with 63.3 g of toluene and 52.3 g of isophorone diisocyanate and the mixture was reacted at 110° C. to a constant NCO content of 3.60. It was allowed to cool and diluted with 211.2 g of toluene and 188.9 g of isopropanol. A solution of 24.2 g of 4,4′-diaminodicyclohexylmethane in 163.4 g of 1-methoxy-2-propanol was added at room temperature. When the molecular weight had finished increasing and the desired viscosity range had been reached, the residual NCO content was blocked by the addition of 1 g of n-butylamine. This gave 904.3 g of a 30.7% solution of polyurethane-urea in toluene/isopropanol/1-methoxy-2-propanol with a viscosity of 22,400 mPas at 22° C.

### Example 7

### Polyurethane-urea Solution According to the Invention Using a polycarbonatepolyol of Example 3 Based on polytetramethylene glycol

This Example describes the preparation of a polyurethane-urea according to the invention.

200 g of a polycarbonatediol of Example 3 according to the invention were mixed with 63.3 g of 1-methoxy-2-propyl acetate and 52.3 g of isophorone diisocyanate and the mixture was reacted at 110° C. to a constant NCO content of 3.60. It was allowed to cool and diluted with 211.2 g of γ-butyrolactone and 188.9 g of isopropanol. A solution of 23.7 g of 4,4′-diaminodicyclohexylmethane in 161.3 g of 1-methoxy-2-propanol was added at room temperature. When the molecular weight had finished increasing and the desired viscosity range had been reached, the residual NCO content was blocked by the addition of 1 g of n-butylamine. This gave 901.7 g of a 30.7% solution of polyurethane-urea in γ-butyrolactone/isopropanol/1-methoxyl-2-propanol with a viscosity of 29,000 mPas at 22° C.

### Example 8

### Use Example

To compare the coating properties, coating films were produced in a layer thickness of 0.5 mm from the polyurethane solutions according to Examples 5-7 and Example 4 (product according to the state of the art/Comparative Example) and tested.

TABLE 1
Elongations at break of the films of the polyurethane solutions
according to the invention and comparison with the standard product

| | | | | Example 4 |
|---|---|---|---|---|
| | | | | (Comparative |
| | Example 5 | Example 6 | Example 7 | Example) |
| Elongation at break | 1040 | 1000 | 1010 | 630 |
| (%) | | | | |

The results show that the polyurethane solutions according to the invention produce coatings with very high elongations at break. The product of the state of the art, on the other hand, produces coatings with markedly lower elongations at break. This indicates that exceptionally elastic coatings can be obtained with the polyurethane solutions according to the invention.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A coating agent based on polyurethane-polyureas comprising the reaction product of
a) a polycarbonatediol component comprising
a1) a polytetramethylene glycol-based polycarbonatediol with a molecular weight of between 400 and 8000, and
a2) optionally other polyols with a molecular weight of between 200 and 8000,
b) 0.5-2.0 mol per mol of a) of a chain extender selected from the group consisting of a low-molecular weight aliphatic or cycloaliphatic diol, a low-molecular weight aliphatic or cycloaliphatic diamine, and hydrazine, and
c) 1.5-3.0 mol per mol of a) of an aliphatic, cycloaliphatic or aromatic diisocyanate,
dissolved in
d) 40-90 percent by weight (based on the total formulation) of an organic solvent selected from the group consisting of linear or cyclic esters, ketones, alcohols, aromatic compounds and mixtures thereof.

2. A coating agent according to claim 1 comprising reaction product of
a) a polytetramethylene glycol-based polycarbonatediol with a molecular weight of between 600 and 3000,
b) 0.5-2.0 mol per mol of a) of a chain extender selected from the group consisting of an aliphatic or cycloaliphatic diamine and hydrazine, and
c) 1.5-3.0 mol per mol of a) of an aliphatic or cycloaliphatic diisocyanate,
dissolved in
d) 50-85 percent by weight (based on the total formulation) of an organic solvent selected from the group consisting of ethyl acetate, n-butyl acetate, 1-methoxy-2-propyl acetate, γ-butyrolactone, acetone, 2-butanone, ethanol, n-propanol, isopropanol, 1-methoxy-2-propanol, solvent naphtha, toluene and mixtures thereof.

3. A process for producing a coating on a substrate comprising applying a coating agent according to claim 1 to a substrate.

4. A process according to claim 3, wherein the coating agent is applied to the substrate by a method selected from the group consisting of printing, spraying, knife coating and transfer coating.

5. A process according to claim 3, wherein the substrate is a textile.

6. A process according to claim 3, wherein the substrate is leather.

7. A process according to claim 3, wherein the coating is a multilayer system.

8. A process according to claim 3, wherein the coating is a covering layer.

9. Substrates coated with coating agents according to claim 1.

10. Polyurethane-polyureas obtained from coating agents according to claim 1.

11. A polyurethane-polyurea made up of
a) a polycarbonatediol component comprising
a1) a polytetramethylene glycol-based polycarbonatediol with a molecular weight of between 400 and 8000, and
a2) optionally other polyols with a molecular weight of between 200 and 8000,
b) 0.5-2.0 mol per mol of a) of a chain extender selected from the group consisting of a low-molecular weight aliphatic or cycloaliphatic diol, a low-molecular weight aliphatic or cycloaliphatic diamine, and hydrazine, and
c) 1.5-3.0 mol per mol of a) of an aliphatic, cycloaliphatic or aromatic diisocyanate.
